(19) United States
(12) Patent Application Publication
(10) Pub. No.: US 2015/0121351 A1
(43) Pub. Date: Apr. 30, 2015

(54) GENERATING CONFIGURATION DATA BASED ON APPLICATION DEFINITIONS

(71) Applicants: Alan Cabrera, El Cerrito, CA (US); Scott Holmes, Morgan Hill, CA (US); Elbert Tsay, San Jose, CA (US)

(72) Inventors: Alan Cabrera, El Cerrito, CA (US); Scott Holmes, Morgan Hill, CA (US); Elbert Tsay, San Jose, CA (US)

(21) Appl. No.: 14/528,757

(22) Filed: Oct. 30, 2014

Related U.S. Application Data
(60) Provisional application No. 61/898,193, filed on Oct. 31, 2013.

(51) Int. Cl. G06F 9/45

(52) U.S. Cl. CPC G06F 8/437
USPC 717/141

(57) ABSTRACT

Configuring a computer-based application on one or more computer systems includes compiling a configuration source to generate a compiled configuration file. Compiling the configuration source may also include accessing an application definition that includes a property definition, where the property definition includes a name attribute and a type attribute. Compiling the configuration source may further include selecting a property source from the configuration source based on the property source having a name attribute that matches the name attribute of the property definition. The property source may also include a value, and a type check may be performed on that value based on the type attribute of the property definition. Thereafter, a configuration property may be recorded in the compiled configuration file, where the configuration property includes a name specified by the name attribute of the property definition and the value of the property source.

### CROSS-REFERENCE TO RELATED APPLICATIONS

This application claims the benefit of priority to U.S. Pat. App. No. 61/898,193, filed Oct. 31, 2013 and titled “GENERATING CONFIGURATION DATA BASED ON APPLICATION DEFINITIONS,” the disclosure of which is incorporated by reference herein in its entirety.

### TECHNICAL FIELD

The present disclosure generally relates to configuring a computer-based application on one or more computer systems. More specifically, the present disclosure relates to methods, systems and computer program products for compiling a configuration file for an application based on an application definition.

### BACKGROUND

Companies rely on applications operating on computer-based infrastructures to provide external services and to facilitate internal operations (e.g., execution of internal business processes, facilitate electronic communication, and the like). In some cases, these applications may span multiple computer-based infrastructure environments. The multiple infrastructure environments may include a data center environment, a cloud computing environment, or any other environment that incorporates computer, network, storage, operating system, application, and other resources. The applications deployed on the infrastructure may use these resources to accomplish various business objectives. The services themselves may span multiple infrastructure environments over the course of a development lifecycle.

In many cases, configuration files may be used to set values needed to deploy or otherwise setup an application in an infrastructure. For example, a configuration file may include an attribute that specifies a cache size needed by the application. However, in some cases, an improper configuration value may lead to bad results. For example, in some cases, the configuration file may specify a cache size that results in unacceptable behavior. When this happens, a stakeholder may attempt to debug or otherwise trouble shoot the issue when the unacceptable behavior is detected.

### BRIEF DESCRIPTION OF THE DRAWINGS

Some embodiments of the technology are illustrated by way of example and not limitation in the figures of the accompanying drawings.

FIG. 1 is a block diagram illustrating various components or functional modules of a configuration compilation service, consistent with some embodiments.

FIG. 2 is a diagram illustrating contents of an application definition, according to an example embodiment.

FIG. 3 is a diagram of a configuration source that may be compiled against the application definition of FIG. 2, according to an example embodiment.

FIG. 4 is a diagram illustrating an example of a compiled configuration file, according to an example embodiment.

FIG. 5 is a flow chart illustrating a method for compiling a configuration source, according to an example embodiment.

FIG. 6 is a diagram illustrating an application definition with a constraint attribute, according to an example embodiment.

FIG. 7 is a block diagram of a machine in the form of a computing device within which a set of instructions, for causing the machine to perform any one or more of the methodologies discussed herein, may be executed.

### DETAILED DESCRIPTION

The present disclosure describes, among other things, methods, systems, and computer program products, which individually provide functionality for generating or otherwise compiling configuration files. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Example embodiments may include systems and methods to configure an application (or applications) deployed on an operational infrastructure based on an application definition and a configuration source. On the one hand, a configuration source may be data (e.g., a file) that specifies one or more configuration properties (key/value pairs) that are to be included in a compiled configuration file. On the other hand, an application definition, as used herein, may refer to data or logic that characterize attributes of a configuration property (or configuration properties) that an application consumes to configure an operational environment in which the application runs on. In a way, the application definition may act as a contract for the data that an application expects in a configuration file. In some embodiments, an application definition may characterize a configuration property by assigning the configuration property a data type. Assigning the configuration property a data type may in some cases provide type safety protection when a configuration file is compiled.

Accordingly, in some embodiments, a configuration compiler may receive a configuration source to compile. In some embodiments, a configuration source may be data that includes one or more configuration properties that are to be included in a compiled configuration file. The configuration compiler may then obtain an application definition related to the configuration source. The application definition may include a property definition that may in turn include a name attribute and a type attribute. The configuration compiler may then inspect the property definition and search the configuration source for a value for the property definition. In some cases, the value may be specified by the configuration source. In other cases, the value may be specified by the application definition. The value found is then type checked against the type attribute of the first property definition. Based on a valid type check, the configuration compiler may record the value in a key value pair in a compiled configuration file. Otherwise, the configuration compiler may generate an error.

In some cases, the configuration compiler may repeat the process of inspecting other property definitions within the application definition and type checking values associated with those application definitions.

Utilizing a configuration compiler in a manner consistent with some of the example embodiments described herein may find many practical applications. For example, a system utilizing application definitions may force stake holders of an application (e.g., developers, designers, operation groups, testers, and the like) to discuss the types of properties that may be configurable, the permissible values of those properties, the impact the property has on the operational infrastructure, and the resources required by the operational infrastructure to support the application, to say the least. Other advantages and aspects of the inventive subject matter will be readily apparent from the description of the figures that follows.

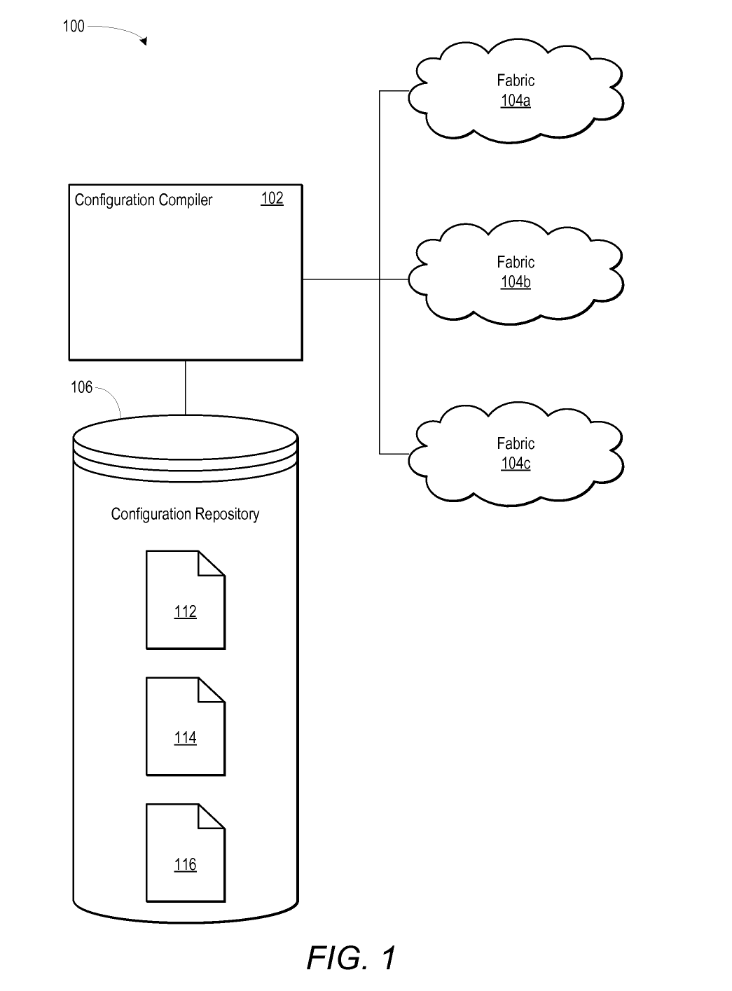

FIG. 1 is a block diagram illustrating various components or functional modules of a configuration compilation service 100, consistent with some embodiments. The modules, systems, and/or engines shown in FIG. 1 represent a set of executable software instructions and the corresponding hardware (e.g., memory and processor) for executing the instructions. However, one skilled in the art will readily recognize that various additional functional modules and engines may be used with the configuration compilation service 100 to facilitate additional functionality that is not specifically described herein. Furthermore, the various functional modules and engines depicted in FIG. 1 may reside on a single server computer, or may be distributed across several server computers in various arrangements

As shown in FIG. 1, configuration compilation service 100 may include a configuration compiler 102 communicatively coupled to one or more fabrics (e.g., fabrics 104a-c) and a configuration repository 106.

The configuration compiler 102 may be a computer-implemented module configured to generate compiled configuration files based on a configuration source and an application definition. Compiling a configuration file may be a process for determining whether a configuration source has been properly defined a configuration property that is consistent with an application definition in which the configuration source is compiled against. An example where a configuration property may not be consistent with an application definition is where the application definition specifies that a property named “cache size” is to have an integer value and the configuration source sets a string value to the “cache size” configuration property. In this example, some embodiments of the configuration compiler 102 may generate an error when the configuration source is compiled.

The fabrics 104a-c may each be an operational environment that may execute an application. Each of the fabrics may include a topology of computer resources, such as webservers, databases, load balancers, web-caches, and the like. Although this disclosure may refer to these computer resources as physical computer resources, it is to be appreciated that these computer resources may also be embodied as virtual resources deployed on physical nodes of a cloud system. In some cases, the fabrics may correspond to a topology of computer resources usable during a stage of the development of the application. For example, the fabric 104a may be the computer environment for testing applications, the fabric 104b may be the computer environment for developing applications, and the fabric 104c may be the computer environment for production.

The configuration repository 106 may be a data store (e.g., one or more databases) that stores, among other things, a compiled configuration file 112 (or configuration files), an application definition 114 (or application definitions), and a configuration source 116. The compiled configuration file 112 may include configuration data that specifies the properties and corresponding values that are to be used to configure an application deployed on one of the fabrics 104a-c. In some cases, the configuration data may specify the properties and corresponding value through key value pairs. The key value pairs are determined by the configuration compiler 102 when the configuration compiler 102 compiles the configuration source.

The application definition 114 is data (e.g., a file) that includes configuration definition data. Configuration definition data may include one or more property definitions that specify configuration properties that may be included in a configuration file. Generally, a property definition is a tuple that includes a name attribute. The name attribute may name a configuration property in the configuration file 112. In addition to the name attribute, an application definition may include other types of attributes. For example, in some cases, a property definition may specify a default value for a configuration property via a default value attribute. In some cases, a property definition may be a pure virtual property definition. A pure virtual property definition may be a property definition that lacks a value and indicates that another application should override the pure virtual property definition with a value. If an application definition includes a pure virtual property definition that is not overridden with a value by a configuration source, example embodiments may generate an error message for an end-user trying to configure an application.

In some embodiments, in addition or in the alternative to including default values and pure virtual property definitions, a property definition may include a type attribute. A type attribute may be data usable to verify that the values specified by a configuration source, or an application definition, is valid. For example, the type attribute for a property definition may specify that the value for a named configuration property is an integer. When this is the case, if any configuration source uses a value that corresponds to a string data type, the configuration compiler 102 may then generate an error indicating that the value in the configuration source 116 is improper or otherwise invalid. By way of example and not limitation, a data type may include integers, strings, floating point, set, map, list, uniform resource locators (“URL”), or any other suitable data format.

The configuration source 116 may be data or logic that the configuration compiler 102 compiles to generate the compiled configuration 112. The configuration source 116, and the corresponding application definition 114, specify the configuration properties that will be included in the compiled configuration.

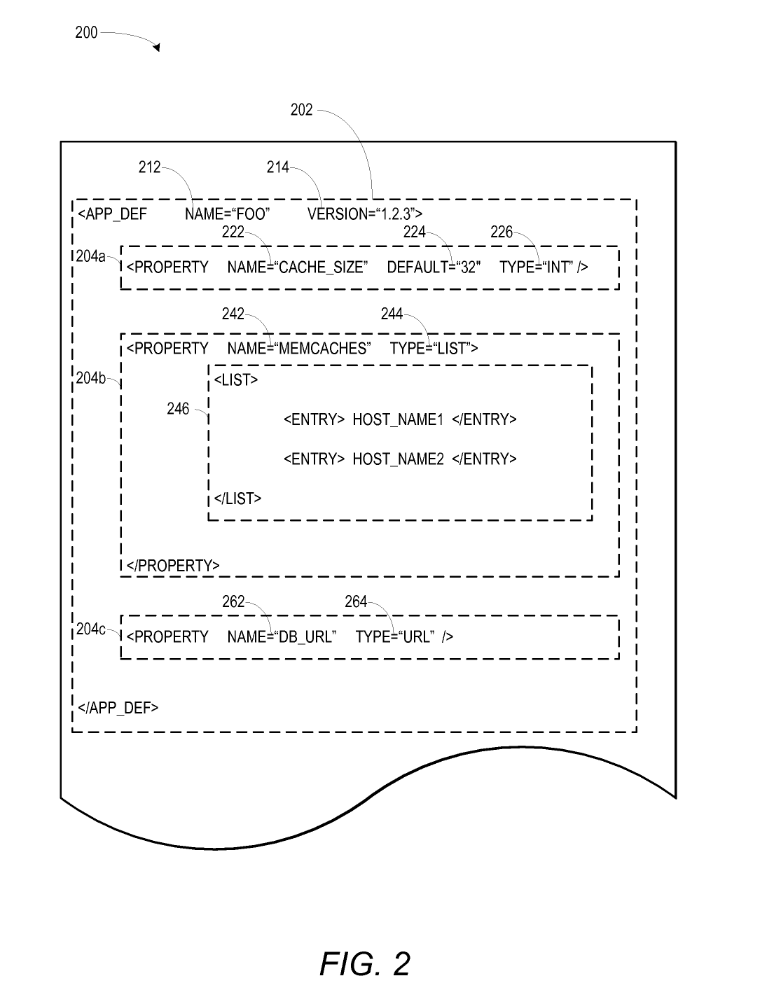

As described above, an application definition 114 may operate, at least conceptually in some embodiments, as a contract defining the types of configurations and possibly values that may be used in a configuration file for an application operating in one of the fabrics 104a-c. The format of the application definition is now described in greater detail. For example, FIG. 2 is a diagram illustrating contents of an application definition 200, according to an example embodiment. As shown in FIG. 2, the application definition 200 may be a file that includes data (e.g., textual data (e.g., ASCII)) according to a format, syntax, and language or grammar. For example, the application definition 200 shown in FIG. 2 may be expressed in XML, or some variation thereof, for example. Other example embodiments of the application definition 200 may of course be expressed in any other suitable formats, whether it be proprietary or a standard format.

As shown in FIG. 2, the application definition 200 includes an application definition component 202 that, in turn, includes multiple property definitions (e.g., the property definitions 204a-c). The application definition component 202 may signify aspects of the application definition through a number of attributes, such as a name attribute 212, version attribute 214, and the like. The name attribute 212 of the application definition component may assign an application definition name (e.g. “FOO”) to the application definition component 202. An application name may be data usable to identify the application definition 200 from other application definitions. The version attribute 214 may be data usable to differentiate different versions of the same application definition (e.g., other application definitions named “FOO,” for example).

Within the application definition component 202, a number of property definitions 204a-c are listed. Each of the property definitions 204a-c may specify aspects or attributes of a configuration property that is to be recorded in a configuration file. For example, a property definition may, among other things, specify a name of a configuration property that is to be included in a configuration file, a default value for a configuration property, a type classifier for a configuration property, expression constraint, and any other aspect. In some cases, the property definition may be specified as a pure virtual property definition. As described above, a pure virtual property definition may be a property definition that lacks a value and, as a result, signals that a configuration source is to specify the value for the corresponding configuration property. These attributes of property definitions are illustrated in FIG. 2 with respect to property definitions 204a-c. For example, the property definition 204a may include a name attribute 222, a default value attribute 224, and a type attribute 226. The name attribute 222 may be an attribute that specifies a name for a configuration property that is to be included in the compiled configuration file. As FIG. 2 shows, the name attribute 222 names the property definition 204a “cache_size.” Thus, the compiled configuration file is to include a configuration property with the name “cache_size.”

The default value attribute 224 may be an optional property definition attribute that specifies a default value for a configuration property that is recorded in the compiled configuration file. The use of default value attributes may in some cases simplify the authoring of configuration sources. For example, if the configuration compiler 102 detects that a value is not specified for a configuration property named by a property definition, the configuration compiler may use the default value specified by the property definition. Of course, the author of a configuration source can override the value specified by the default value attribute by providing another value for the configuration property.

The type attribute 226 may be an optional attribute that specifies a type classifier for a configuration property corresponding to the name attribute. For example, the type attribute 226 specifies that the “cache_size” is an integer type. Accordingly, the configuration compiler 102 may verify any value associated with the property definition 204a as being consistent with an integer. For example, the deployment manger 102 may verify that the default value (e.g., 32) is an integer. Although the type attribute 226 specifies an “INT,” or integer, type, it is to be appreciated that other types are contemplated by this disclosure. For example a type attribute may specify a float, string, URL, map, set, list, or any other data type.

The property definition 204b includes the name attribute 242 to name another configuration property (e.g., “MEMCACHES”) that is to be included in the compiled configuration file. The type attribute 244 may specify that the value for the configuration property corresponding to the name attribute 242 is a list and, thus, must follow the syntax of a list data type. As FIG. 2 shows, the default value 246 is compliant with a list data type. If it didn't, the configuration compiler 102 may generate an error to the end-user that the value for the property definition 204b is invalid. It should be noted since the default value 246 is of a complex data type (e.g., a list or other nested data type), the default value 246 is listed within the property tags of the property definition 204b rather than through a default value attribute, such as the default value attribute 224 of the property definition 204a.

The property definition 204c includes the name attribute 262 to name another configuration property (e.g., “DB_URL”) that is to be included in the compiled configuration file. It is worth noting that the property definition 204c may be considered a pure virtual property definition in that the property definition 204c lacks a value attribute. For example, the property definition 204c lacks a default value attribute, as was defined for the property definition 204a. Further, the property definition 204c also lacks an explicit value, as was defined for the property definition 204b. In being a pure virtual property definition, the configuration compiler 202 may generate an error if it compiles a configuration source that doesn't define a value for the property definition 204a.

Although the property definition 204c lacks a default value, the property definition 204c may still include, although not necessarily, a type attribute 264. The type attribute 264 may specify a type that the configuration compiler 102 will check when the configuration source defines the value for the property definition 204c.

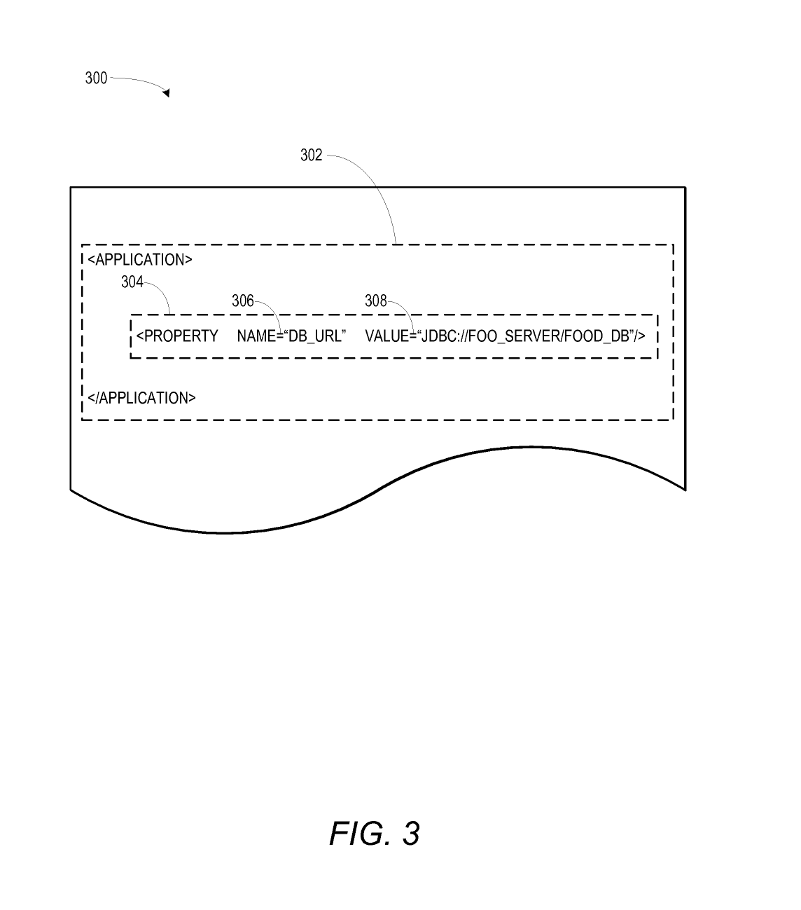

FIG. 3 is a diagram of a configuration source 300 that may be compiled against the application definition 200 of FIG. 2, according to an example embodiment. The configuration source 300 includes a configuration source component 302 that, in turn, includes a property source 304. The property source 304 may include a name attribute 306 specifying a name of a configuration property that is to be included in the compiled configuration file. As may be recalled from the above discussion relative to FIG. 2, the application definition 200 of FIG. 2 may have included a pure virtual property definition (e.g., the property definition 204c) that had a name attribute (name attribute 262) that matches the name attribute 306 of the property source 304. Thus, both the property source 304 and the property definition relate to the same configuration property that is to be in the compiled configuration file. However, unlike the property definition 204c, the property source 304 includes a value attribute 308. As shown in FIG. 3, the value attribute 308 has been set to the value “JDBC://FOO_SERVER/FOO_DB.” Because the property source 304 shares the same name attribute as the property definition 204c of FIG. 2, the property source 304 may be said to override the value of the property definition 204c. Thus, the value of the “DB_URL” property definition is “JDBC://FOO_SERVER/FOO_DB” by virtue of the value attribute 308. Further, because the property source 304 provides a value attribute 308 for the “DB_URL,” the configuration compiler 102 will abstain from generating an error message as a result of a pure virtual property definition (e.g., the property definition 104c) not being overridden by a child application definition. The configuration compiler will, however, type check the value attribute 308 against the type attribute 264 of the property definition 204c.

It is to be appreciated that the application definition 200 and the configuration source 300 shown in FIGS. 2 and 3, respectively, are provided merely as examples and should not be interpreted as being provided to limit the scope of other example embodiments contemplated by this disclosure. For example, other example embodiments may use application definitions that specify more or less property definitions in any number of different formats.

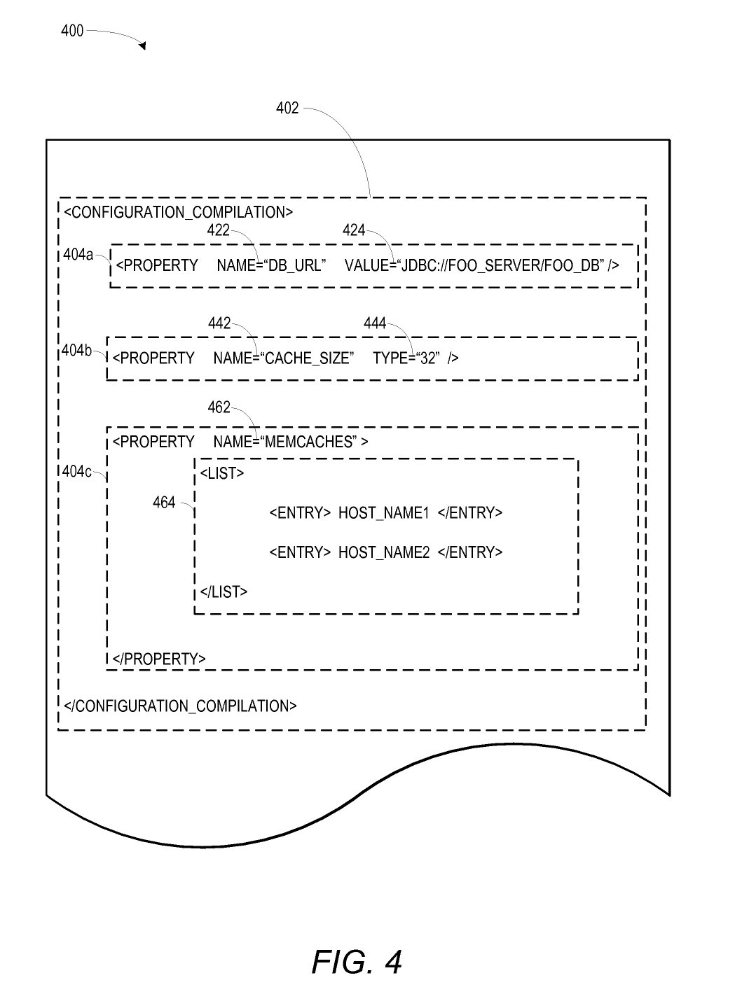

Example embodiments may use the application definition 200 and the configuration source 300 shown in FIGS. 2 and 3, respectively, to generate configuration data, such as the compiled configuration file 112 shown in FIG. 1. FIG. 4 is a diagram illustrating an example of a compiled configuration file 400, according to an example embodiment. As discussed above, a compiled configuration file 400 may be data consumed by an application as part of application start-up or deployment to set-up the run-time environment. As shown in FIG. 4, the compiled configuration file 400 may include a configuration component 402. The configuration component 402 may be a section in the configuration data 400 that includes one or more configuration properties, such as configuration properties 404a-c.

Each of the configuration properties 404a-c may specify a configuration value for a configurable aspect of the application or the operational environment of the fabric which executes the application. In some cases, a configuration property may specify the configuration value for the configurable aspect through a key value pair. For example, the configuration property 404a includes a name attribute 422 (e.g., the key) and a value attribute 424 (e.g., the value). The configuration compiler 102 may generate the configuration property 404a based on the property definition 204c specified by the application definition 200 of FIG. 2 and the value attribute 308 specified by the property source 304 specified by the source application 300 of FIG. 3. It is to be appreciated that the property source 304 may override the property definition 204c because the property definition 304 and the property definition 204c share the same name (name attribute 306 matches name attribute 262).

With continued reference to FIG. 4, the configuration compiler 102 may generate the configuration property 404b based on the property definition 204a specified by the application definition 200 of FIG. 2. That is, the name attribute 442 and the value attribute 444 are assigned values specified by the name attribute 222 and the default value attribute 224. It is to be appreciated that because the configuration source 300 of FIG. 3 lacks a property source with a name attribute matching the name attribute 222 of application definition 200, the default value attribute 224 is not overridden. Thus, the configuration property 402b is assigned a value specified by the default value attribute 224.

Still further, with continued reference to FIG. 4, the configuration compiler 102 may generate the configuration property 404c based on the property definition 204b specified by the application definition 200 of FIG. 2. That is, the name attribute 462 and the value attribute 464 are assigned values specified by the name attribute 242 and the default value attribute 246. It is to be appreciated that because the configuration source 300 of FIG. 3 lacks a property definition with a name attribute matching the name attribute 242 of application definition 200, the default value attribute 264 is not overridden. Thus, the configuration property 402c is assigned a value specified by the default value attribute 246.

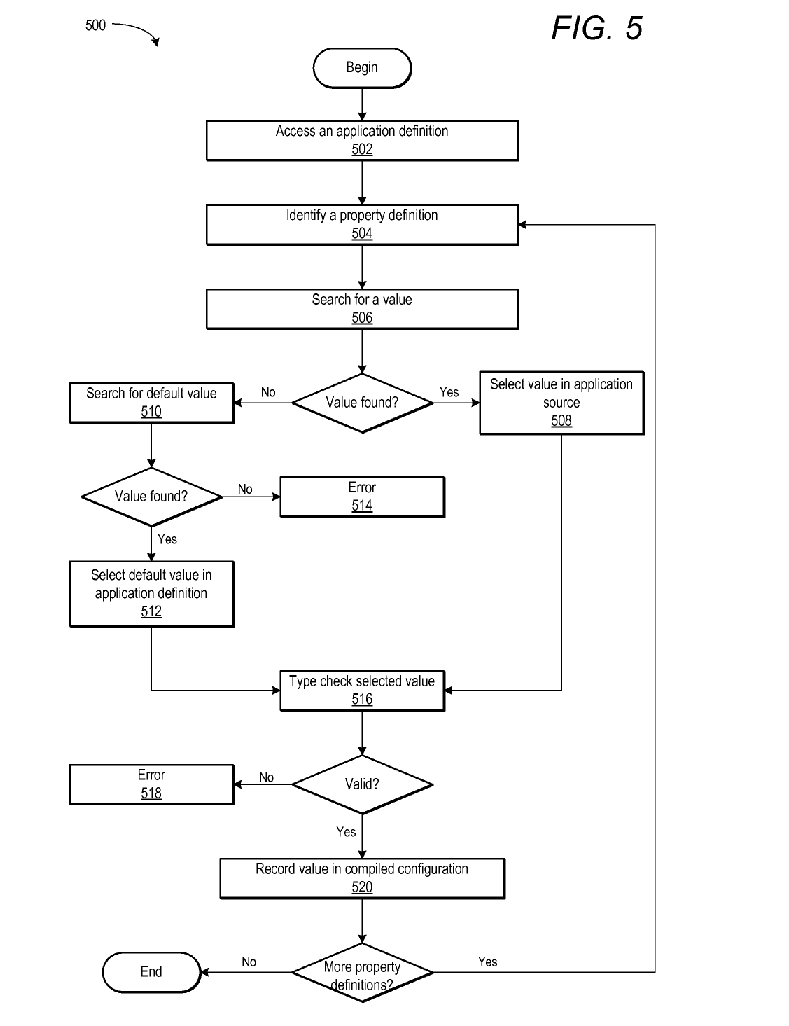

The operation of the configuration compiler 102 is now described in greater detail. FIG. 5 is a flow chart illustrating a method 500 for compiling a configuration source, according to an example embodiment. The method 500 may be performed by the configuration compiler 102 and, accordingly, is described herein, merely by way of example, with reference thereto. However, it will be appreciated that the method 500 may be performed on any suitable hardware. The method 500 may also be performed by operating on the application definition 200 and the configuration source 300 shown in FIGS. 2-3, respectively, and, accordingly, is described herein merely by way of reference thereto. However, it will be appreciated that the method 500 may be performed on any other suitable data structure.

The method 500 may begin at operation 502 when the configuration compiler 102 accesses an application definition (e.g., the application definition 200 of FIG. 2) from the configuration repository 106 during the compilation of a configuration source (e.g., the configuration source 300 of FIG. 3). In some embodiments, the operation 502 may be performed as part of a process of generating a compiled configuration file usable to configure an application hosted on one of the fabrics 104a-c, or in preparation thereof.

At operation 504, the configuration compiler 102 may identify a property definition from the application definition 200 that includes a name attribute and a type attribute. In some cases, the deployment manger 102 may perform operation 504 by parsing the application definition to identify tokens matching the syntax of a name attribute (and corresponding name value) and tokens matching the syntax of a type attribute (and corresponding type value).

At operation 506, the configuration compiler 102 may search the configuration source 300 for a property source with a name attribute matching the property definition. In some cases, a property source with a name attribute matching the name attribute of the property definition may be found in the configuration source and in some cases it will not. For example, in the case of a pure virtual property definition, the configuration source may include a source property specifying a value for the pure virtual property definition. On the other hand, in the case of default values, the configuration source may lack a property source that corresponds to the property definition.

If a property source with a name attribute matching the property definition is found in the configuration source 300, the value specified by the configuration source is selected for type checking. This is shown as operation 508. By way of example and not limitation, if the property definition 204c is identified at operation 504 and the configuration source 300 of FIG. 3 is searched, the value attribute 308 shown in FIG. 3 may be selected at operation 508 because the value attribute 308 is part of a property source (e.g., property source 304) that has a name attribute (e.g., name attribute 306) that matches the name attribute of the property definition 204c.

If the value for the property definition is not found in the configuration source 300, the configuration compiler 102 may determine, at operation 510, whether the property definition 200 specifies a default value. If the property definition 200 specifies a default value for the identified property definition, the default value is selected for type checking. This is shown as operation 512. It should be noted that in the case of the property definitions 204a-b, the default value attributes 224 and 246 may be selected as the configuration source 300 of FIG. 3 lacks any property sources that match these property definitions.

If the property definition 200 does not specify a default value for the identified property definition, the configuration compiler 102 may generate an error at operation 514.

At operation 516, the configuration compiler 102 may then perform a type check on the selected value. Type checking the selected value may involve the configuration compiler 102 comparing the selected value with the value of the type attribute. For example, where the type attribute specifies an integer, the configuration compiler 102 may verify that the selected value of the value attribute is a valid integer. In the case of values for complex data types, or values dependent on the values of other configuration properties, type checking may involve building up the value to check against the type attribute specified by the application definition.

If the type check fails, the configuration compiler 102 may generate an error message. This is shown as operation 518. In some cases, generating an error message ends the method 500. In other cases, the method 500 may continue despite encountering an error.

The method 500 continues to operation 520 if the type check determines that the value attribute is a valid type. Operation 520 may include the configuration compiler 102 recording a configuration property in the compiled configuration file based on the name specified by the name attribute of the property definition and the value of the selected value attribute.

As FIG. 5 shows, the configuration compiler 102 loops back to operation 504 if there are more property definitions in the property definition 200. Otherwise, the method 500 ends.

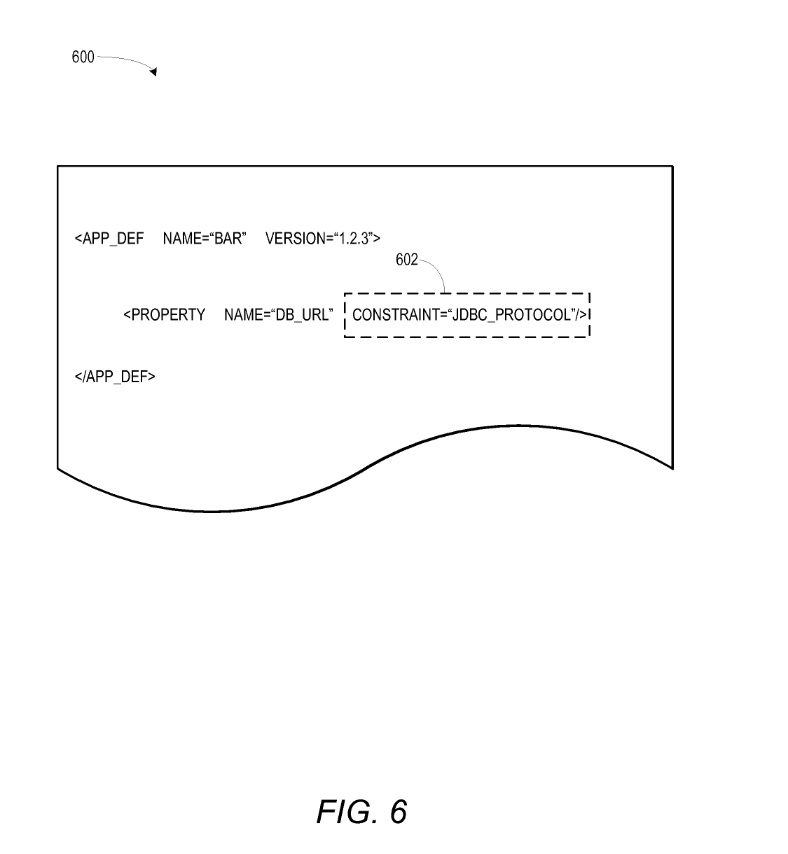

Thus far, this disclosure has focused on generating configuration data based on application definitions that may include type safety checks. However, other example embodiments may additionally or alternatively include any number of validity checks on the value attributes specified by the application definitions used to generate configuration data. For example, FIG. 6 is a diagram illustrating an application definition 600 with a constraint attribute 608, according to an example embodiment. The constraint attribute 608 may be an attribute of a property definition that specifies a constraint on a value attribute specified for that property definition. In the case of FIG. 6, the constraint attribute 608 may specify a JDBC_PROTOCOL constraint, which may be shorthand used by this disclosure to represent, for example, a regular expression usable to identify a URL utilizing the JDBC protocol (as compared to a URL utilizing HTTP). In other embodiments other types of constraints may be provided. For example, other example embodiments may provide a range constraint to define a range of values a value attribute is to be within to be considered valid. Other example embodiments may provide a max constraint to define a maximum value a value attribute may specify or a minimum value a value attribute may specify. The validation of constraint attributes may be performed by operation 516 of the method 500 of FIG. 5.

It is possible that example embodiments may be used to provide many practical advantages in configuring applications running on computational environments. For example, rather than authoring configuration data directly, stakeholders of an application may discuss the computational needs of the application prior to deployment to develop application definitions. The application definitions are then used to generate configuration data. In generating the configuration data, the configuration compiler is able to detect errors that violate the property definitions specified by one or more of the application definitions (e.g., an application definition specifies data in an incorrect format, for example). In many cases, errors detecting during the compilation of application definitions is less consuming than bug finding in a deployed application.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

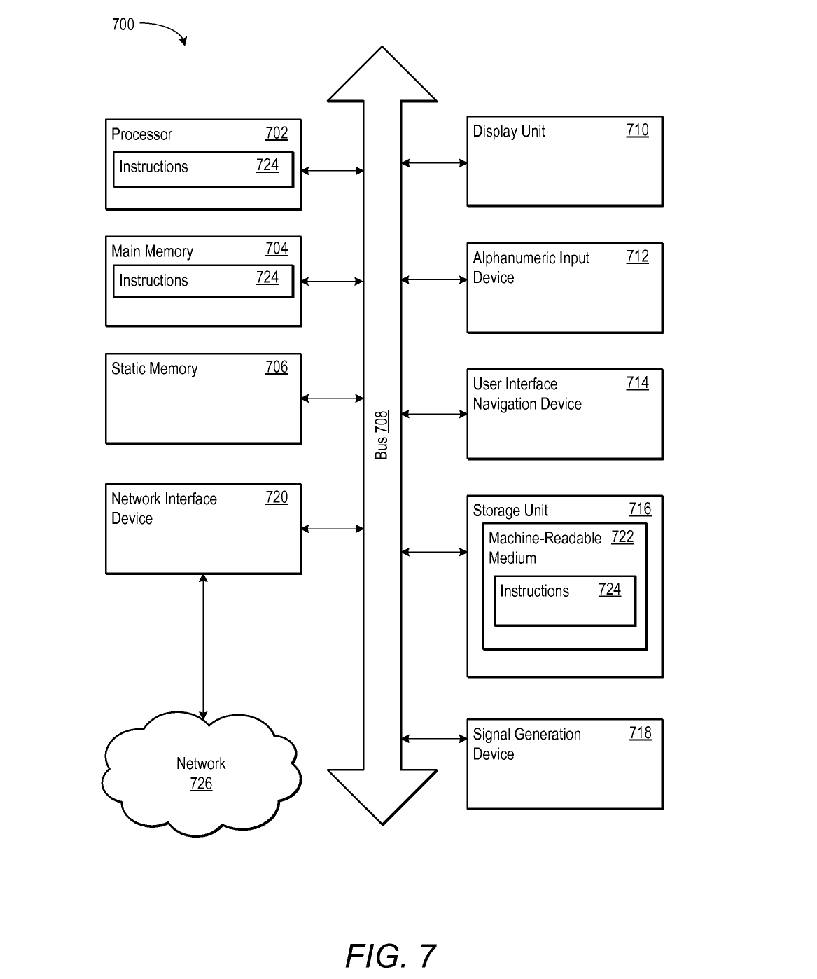

FIG. 7 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a display unit 710, an alphanumeric input device 712 (e.g., a keyboard), and a user interface (UI) navigation device 714 (e.g., a mouse). In one embodiment, the display, input device and cursor control device are a touch screen display. The computer system 700 may additionally include a storage device 716 (e.g., drive unit), a signal generation device 718 (e.g., a speaker), a network interface device 720, and one or more sensors, such as a global positioning system sensor, compass, accelerometer, or other sensor.

The drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 724 may further be transmitted or received over a communications network 726 using a transmission medium via the network interface device 720 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although some embodiments has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A computer-implemented method comprising:
compiling, with one or more processors, a configuration source to generate a compiled configuration file, the compiling including:
accessing an application definition that includes a property definition, the property definition including a name attribute and a type attribute;
selecting a property source from the configuration source based on the property source including a name attribute matching the name attribute of the property definition, the property source specifying a value;
performing a type check on the value based on the type attribute of the property definition; and
based on a valid type check, recording a configuration property in the compiled configuration file, the configuration property including a name specified by the name attribute of the property definition and the value of the property source.

2. The computer-implemented method of claim 1, wherein the type attribute specifies at least one of: an integer, a float, a map, a set, a list, a string, a uniform resource locator, a time, a date, or a location.

3. The computer-implemented method of claim 1, wherein the compiled configuration file is operable to configure an application operating on a fabric.

4. The computer-implemented method of claim 1, wherein the property definition includes a default value attribute.

5. The computer-implemented method of claim 4, wherein the default value attribute is absent from the compiled configuration file.

6. The computer-implemented method of claim 1, wherein the application definition that includes an additional property definition, the additional property definition including an additional name attribute and an additional type attribute.

7. The computer-implemented method of claim 6, wherein the compiling the configuration source to generate the compiled configuration file further comprises:
selecting the additional property definition from the application definition based on the configuration source lacking a property source matching the additional name attribute, the additional property definition specifying a default value attribute;
performing a type check on the default value attribute value based on the type attribute of the property definition; and
based on a valid type check, recording an additional configuration property in the compiled configuration file, the additional configuration property including a name specified by the name attribute of the additional property definition and a value specified by the default value attribute.

8. The computer-implemented method of claim 6, wherein the compiling the configuration source to generate the compiled configuration file further comprises:
selecting the additional property definition from the application definition based on the configuration source lacking a property source matching the additional name attribute; and
generating an error based on the additional property definition lacking a default value attribute.

9. The computer-implemented method of claim 6, wherein the compiling the configuration source to generate the compiled configuration file further comprises:
selecting an additional property source from the configuration source based on the additional property source including a name attribute matching the name attribute of the additional property definition, the additional property source specifying a value;
performing a type check on the value specified by the additional property source based on the additional type attribute of the additional property definition; and
based on an invalid type check, generating an error message indicating that the value specified by the additional property source is of an invalid type.

10. The computer-implemented method of claim 8, wherein the error message further indicating that a type associated with the additional type attribute.

11. A computer system comprising:
at least one processor;
a configuration compiler implemented by the at least one processor and configured to compile a configuration source to generate a compiled configuration file by:
accessing an application definition that includes a property definition, the property definition including a name attribute and a type attribute;
selecting a property source from the configuration source based on the property source including a name attribute matching the name attribute of the property definition, the property source specifying a value;
performing a type check on the value based on the type attribute of the property definition; and
based on a valid type check, recording a configuration property in the compiled configuration file, the configuration property include a name specified by the name attribute of the property definition and the value of the property source.

12. The computer system of claim 11, wherein the type attribute specifies at least one of: an integer, a float, a map, a set, a list, a string, a uniform resource locator, a time, a date, or a location.

13. The computer system of claim 11, wherein the compiled configuration file is operable to configure an application operating on a fabric.

14. The computer system of claim 11, wherein the property definition includes a default value attribute.

15. The computer system of claim 14, wherein the default value attribute is absent from the compiled configuration file.

16. The computer system of claim 11, wherein the application definition that includes an additional property definition, the additional property definition including an additional name attribute and an additional type attribute.

17. The computer system of claim 16, wherein the compiling the configuration source to generate the compiled configuration file further comprises:
selecting the additional property definition from the application definition based on the configuration source lacking a property source matching the additional name attribute, the additional property definition specifying a default value attribute;
performing a type check on the default value attribute value based on the type attribute of the property definition; and
based on a valid type check, recording an additional configuration property in the compiled configuration file, the additional configuration property including a name specified by the name attribute of the additional property definition and a value specified by the default value attribute.

18. The computer system of claim 16, wherein the compiling the configuration source to generate the compiled configuration file further comprises:
selecting the additional property definition from the application definition based on the configuration source lacking a property source matching the additional name attribute; and
generating an error based on the additional property definition lacking a default value attribute.

19. The computer system of claim 16, wherein the compiling the configuration source to generate the compiled configuration file further comprises:
selecting an additional property source from the configuration source based on the additional property source including a name attribute matching the name attribute of the additional property definition, the additional property source specifying a value;
performing a type check on the value specified by the additional property source based on the additional type attribute of the additional property definition; and
based on an invalid type check, generating an error message indicating that the value specified by the additional property source is of an invalid type.

20. A non-transitory computer-readable medium storing executable instructions thereon, which, when executed by a processor, cause the processor to perform operations comprising:
compiling, with one or more processors, a configuration source to generate a compiled configuration file, the compiling including:
accessing an application definition that includes a property definition, the property definition including a name attribute and a type attribute;
selecting a property source from the configuration source based on the property source including a name attribute matching the name attribute of the property definition, the property source specifying a value;
performing a type check on the value based on the type attribute of the property definition; and
based on a valid type check, recording a configuration property in the compiled configuration file, the configuration property include a name specified by the name attribute of the property definition and the value of the property source.
